(19) United States
(12) Patent Application Publication
(10) Pub. No.: US 2022/0348007 A1
(43) Pub. Date: Nov. 3, 2022

(54) WARMING SYSTEM FOR AN INKJET PRINTHEAD

(71) Applicant: Hewlett-Packard Development Company, L.P., Spring, TX (US)

(72) Inventors: Eric Thomas Martin, Corvallis, OR (US); Rogelio Cicili, San Diego, CA (US); Daryl Eugene Anderson, Corvallis, OR (US)

(73) Assignee: Hewlett-Packard Development Company, L.P., Spring, TX (US)

(21) Appl. No.: 17/297,636

(22) PCT Filed: Jul. 17, 2019
(86) PCT No.: PCT/US2019/042224

§ 371 Date: May 27, 2021

(51) Int. Cl. B41J 2/045

(52) U.S. Cl. CPC B41J 2/04528; B41J 2/04563; B41J 2/04581; B41J 2/04588

(57) ABSTRACT

In one example, a warming system for a region of multiple ejector elements on an inkjet printhead includes a warming circuit having a heating element distinct from any of the ejector elements and a controller programmed to selectively energize the heating element only upon determining none of the ejector elements in the region is active.

### BACKGROUND

An inkjet printhead may include warming circuits with resistive heating elements to help keep the printhead above a threshold temperature.

### DRAWINGS

FIG. 1 illustrates a printhead implementing one example of a warming system.

FIG. 2 illustrates one example set of signals to control a warming circuit in a system such as that shown in FIG. 1.

FIG. 3 illustrates one example of a warming system such as might be implemented in a printhead shown in FIG. 1.

FIG. 4 illustrates another example of a warming system such as might be implemented in a printhead shown in FIG. 1.

FIG. 5 illustrates a printhead implementing another example of a warming system.

FIG. 6 illustrates a printhead implementing another example of a warming system.

The same part numbers designate the same or similar parts throughout the figures. The figures are not necessarily to scale.

### DESCRIPTION

The peak power consumed by an inkjet printhead effects the size and thus the cost of the power supply on the printer as well as the power connections to the printhead. Peak power consumption may also effect the manufacturing processes used to build the printhead, particularly the power connections to the ejector circuits. Lowering the peak power consumed by the printhead can reduce the size of the power supply and allow the use of less costly parts and manufacturing processes, all of which helps lower the cost of the printer. For warming systems in which the heating element(s) used to warm the printhead are distinct from the ejector elements, so-called “trickle” warming, energizing the heating elements at the same time the ejector elements are active increases peak power consumption. It is desirable, therefore, to supply power to the trickle warming circuits only when the ejector elements are inactive. However, it has been a continuing challenge in the past to effectively and efficiently control the supply of power to trickle warming circuits due to the comparatively large space on the printhead needed to accommodate both the warming circuits and logic circuits to control the warming circuits for more efficient warming.

Accordingly, a new warming system has been developed with streamlined control logic and a smaller “footprint” that, in combination with recent advances in MOS fabrication, enables effective and efficient controlled trickle warming—powering the warming circuits only when the ejector elements are inactive—to lower peak power consumption within the tight space constraints on a printhead. In one example, a warming system for an inkjet printhead includes a single warming circuit with the heating element distinct from any of the ejector elements, and a controller programmed to selectively energize the heating element only when (1) the printhead is below a threshold temperature and (2) none of the ejector elements is active. If the printhead is organized into regions, for example multiple warming regions and/or multiple ejector control regions, the warming system may include a warming circuit and a controller for each region. Each controller may be implemented, for example, as a logic circuit integrated into the printhead, an ASIC integral to or discrete from the printhead, or other suitable logic circuitry that monitors a thermal sensor and the ejector activation signals for each region, to energize the heating element in the corresponding warming circuit only when the temperature is low and none of the ejector elements is active.

These and other examples described below and shown in the figures illustrate but do not limit the scope of the patent, which is defined in the Claims following this Description.

As used in this document: “and/or” means one or more of the connected things; and the temperature of a printhead or the temperature of a region of the printhead means a temperature that represents the temperature of the printhead or region of the printhead for purposes of warming.

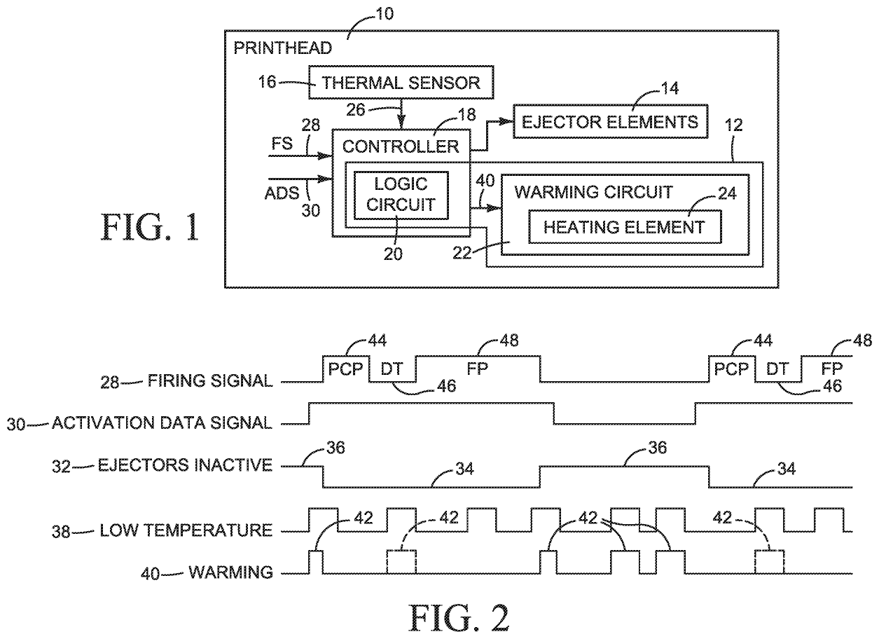

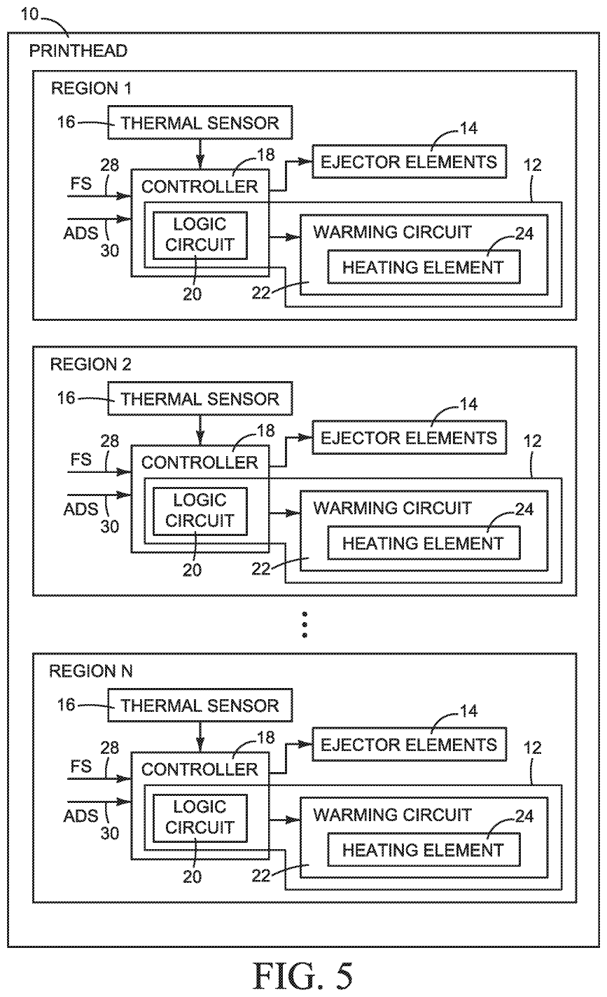

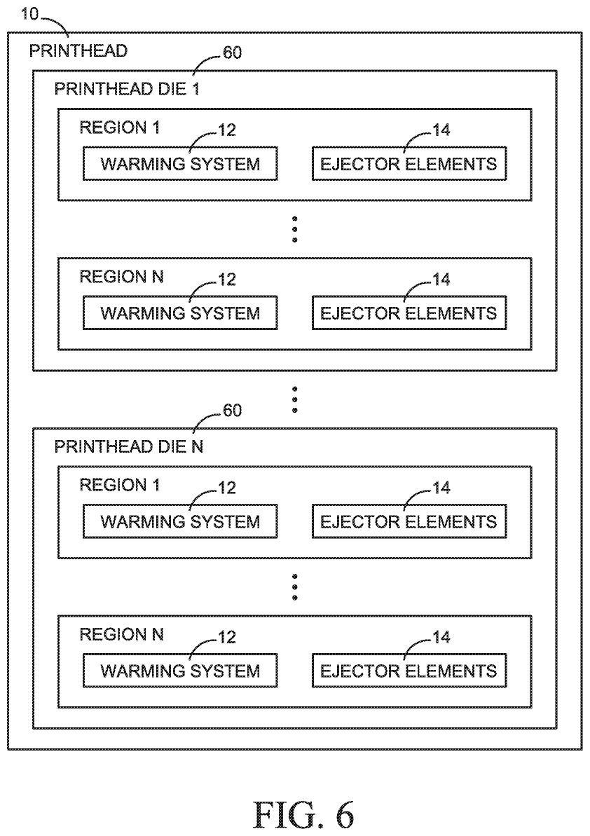

FIG. 1 illustrates a printhead 10 implementing one example of a warming system 12. Referring to FIG. 1, printhead 10 includes warming system 12, ejector elements 14 to eject ink or another printing fluid to a substrate, a thermal sensor 16 to sense the temperature of printhead 10, and a controller 18. A printhead 10 may include multiple warming systems 12 for corresponding regions of the printhead with corresponding groups of ejector elements 14, for example as described below with reference to FIGS. 5 and 6. Ejector elements 14 may be implemented, for example, as thermal or piezoelectric ejector elements. Controller 18 represents the processing and memory resources, programming, and the electronic circuitry and components needed to control the operative elements of printhead 10, for example at the direction of a printer controller. While it is expected that printhead controller 18 usually will be implemented through logic circuitry integral to printhead 10, an ASIC and/or other circuitry configured to perform the desired control functions, controller 18 may be implemented with a general purpose processor executing instructions retrieved from a memory.

Warming system 12 includes a logic circuit 20 and a warming circuit 22 with a heating element 24. Logic circuit 20 represents the programming on controller 10 to selectively energize heating element 24 only when thermal sensor 16 senses that the temperature of printhead 10 is below a threshold temperature and when none of the ejector elements 14 is active. While logic circuit 20 is shown as a discrete element in controller 18, logic circuit 20 may an integrated with other elements of controller 18. Also, thermal sensor 16 may not, and usually will not, sense the temperature everywhere on printhead 10. Therefore, as noted above, reference to the temperature of the printhead or of a region of the printhead means a temperature that represents the temperature of the printhead or region of the printhead for purposes of warming.

Controller 18 is programmed to detect a signal 26 from thermal sensor 16 and to detect a firing signal 28 and an activation data signal 30 from the printer controller, another signal generator or from within the controller 18 itself where controller 18 generates signals 28 and 30. Also, thermal sensor 16 may be integrated into controller 18. Detection programming may be implemented, for example, through any suitable signal detector or detection circuitry.

In the example shown in FIG. 1, controller 18 receives and processes a signal 26 from thermal sensor 16 and firing signal 28 and activation data signal 30 from the printer controller or another signal generator. In one example, thermal signal 26 indicates that the temperature of printhead 10 is below a threshold temperature (i.e., a low temperature signal). In another example, thermal signal 26 indicates the temperature of printhead 10 and controller 10 determines if the sensed temperature is below the threshold. Firing signal 28 and activation data signal 30 together selectively activate ejector elements 14 to eject ink or another fluid to a substrate. In the example shown in FIG. 1, controller 18 detects signals 28 and 30 from an “upstream” signal generator. In other examples, controller 10 may generate one or both signals 28 and 30.

FIG. 2 illustrates one example set of signals to control a warming circuit 22 in FIG. 1. Referring to FIGS. 1 and 2, controller 18 is programmed to generate an “ejectors inactive” signal 32 based on determinations made about firing signal 28 and activation data signal 30. In the example shown in FIG. 2, ejectors inactive signal 32 is low when controller 18 determines that both signals 28 and 30 are high, as indicated at low lines 34 in FIG. 2. Ejectors inactive signal 32 is high when controller 18 determines that either or both signals 28 and 30 is low, as indicated by pulses 36 in FIG. 2. Controller 18 also generates a low temperature signal 38 from thermal sensor signal 26. Low temperature signal 38 is high only when thermal sensor 16 signals a temperature below the threshold temperature. Controller generates a warming signal 40 that is high to energize heating element 24 only upon determining both ejectors inactive signal 32 and low temperature signal 38 are high, as indicated by pulses 42 in FIG. 2.

Firing signal 28 may include a precursor pulse (PCP) 44, followed by a dead time (DT) 46, and then a firing pulse (FP) 48. In one example, controller 18 is programmed to keep warming signal 40 low during dead time 46 as shown by the solid line pulses 42 in FIG. 2. In another example, depending on the duration of dead time 46, it may be possible (and desirable) to program controller 18 to make warming signal 40 high during dead time 46, as indicated by dashed line pulses 42 in FIG. 2, to increase warming without also increasing peak power consumption.

In one example, ejector inactive signal 32 is generated through logic circuit 20. In another example, ejector inactive signal 32 is generated through other logic circuitry on controller 18 and signal 32 transmitted as an input to logic circuit 20. Also, in the example shown in FIGS. 1 and 2 controller 18 processes thermal sensor signal 26, firing signal 28, and activation data signal 30 to generate signals 32 and 38. In other examples, it may be possible to use a thermal sensor signal 26, a firing signal 28, and/or an activation data signal 30 without further processing to generate warming signal 40, depending on the characteristics of each signal 26, 28, and 30 and logic circuit 20.

Accordingly, ejector elements 14 are deemed to be “active” or “inactive” based on which and how much of firing signal 28 and/or activation data signal 30 are used to generate ejectors inactive signal 32, or to generate warming signal 40 using either or both of signals 28 and 30 without processing by controller 18.

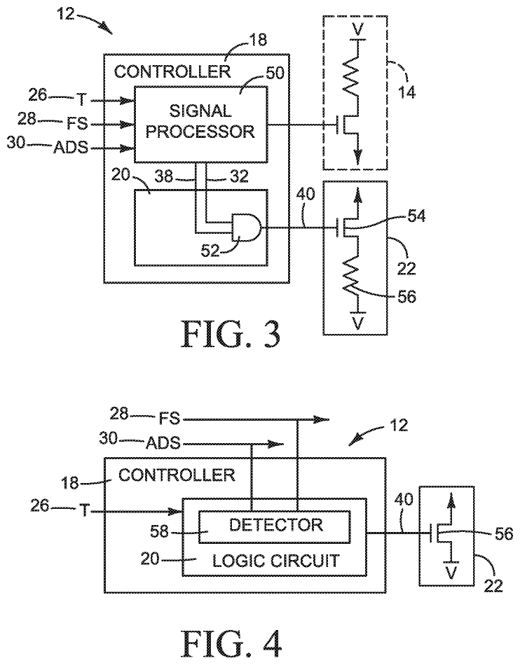

FIG. 3 illustrates one example of a warming system 12 such as might be implemented in a printhead 10 shown in FIG. 1. Referring to FIG. 3, warming system 12 includes a controller 18 programmed through a signal processor 50 and a logic circuit 20 with an AND gate 52. Warming system 12 also includes a warming circuit 22 with a field effect transistor 54 and a resistor for heating element 56. The output from AND gate 52 is high (i.e., in an active state) only when both ejectors inactive signal 32 and low temperature signal 38 are high so that controller 18 drives transistor 54 through AND gate 52 to energize resistor 56 only when the temperature is low and none of the ejector elements 14 is active, for example as described above with reference to FIGS. 1 and 2. AND gate 52 is just one example structure to implement a logic function to selectively energize a heating element 24 in a warming circuit 22. Other suitable structural implementations are possible.

FIG. 4 illustrates another example of a warming system 12 such as might be implemented in a printhead 10 shown in FIG. 1. Referring to FIG. 4, warming system 12 includes a controller 18 programmed through a logic circuit 20 with a signal detector 58. Warming system 12 also includes a warming circuit 22 with a field effect transistor for heating element 56. Logic circuit 20 drives transistor 56 only when detector 58 detects that firing signal 28 and/or activation data signal 30 is high and only when temperature signal 26 indicates a low temperature, for example as described above with reference to FIGS. 1 and 2.

FIG. 5 illustrates another example of a printhead 10 in which ejector elements 14 are grouped into regions 1 through N. Referring to FIG. 5, each region 1-N includes a warming system 12, ejector elements 14, a thermal sensor 16, and a controller 18. In one example, each region 1-N in FIG. 4 represents one of multiple printhead dies. In another example, each region 1-N in FIG. 4 represents a group of ejector elements and a corresponding controller 18 and warming system 12. In another example, each region 1-N in FIG. 4 represents ejector elements grouped together for more effective warming. Each element in each region 1-N is structured and functions as described above with reference to FIGS. 1-3.

FIG. 6 illustrates another example printhead 10 that includes multiple printhead dies 60. The ejector elements 14 on each printhead die 60 are grouped into multiple regions 1 through N with each region including a warming system 12 described above with reference to FIGS. 1-4. An inkjet printhead 10 shown in FIG. 6 may have several dies 60. Each printhead die 60 may include thousands of ejector elements grouped into hundreds of “primitives” each containing multiple ejector elements. Each such printhead die 60 may include dozens of thermal zones each encompassing multiple primitives and each with a corresponding warming system 12.

For an inkjet printhead that includes multiple thermal control regions as shown in FIGS. 5 and 6, it may be desirable to consider the activity of ejector elements in an adjoining region to further reduce peak power consumption. Accordingly, in one example, the controller and/or other logic circuitry for each warming system 12 in a corresponding thermal control region 1 through N is programmed to energize the heating element only upon determining all of the ejector elements in that region and all of the ejector elements in one or more of the adjoining regions are inactive.

In other examples, the heating element in a warming circuit may be energized without regard to temperature, but still only when none of the ejector elements in the region is active. For such “temperature independent” warming, the printhead, or regions of the printhead, may not include a thermal sensor and the corresponding temperature control circuitry described above. (The example shown in FIG. 6 does not include a thermal sensor 16.) While temperature independent warming may reduce peak power consumption, it may do so at the expense of increased overall warming power consumption and thus may not be desirable or even appropriate for some printhead applications.

The examples shown in the figures and described above illustrate but do not limit the patent, which is defined in the following Claims.

“A” and “an” used in the claims to introduce something means one or more the thing and subsequent reference to “the” thing means one or more of the thing.

1. A warming system for a region of multiple ejector elements on an inkjet printhead, the warming system comprising:
a warming circuit having a heating element distinct from any of the ejector elements; and
a controller programmed to selectively energize the heating element only upon determining none of the ejector elements in the region is active.

2. The warming system of claim 1, wherein the controller is programmed to selectively energize the heating element only upon determining the region is below a threshold temperature and none of the ejector elements in the region is active.

3. The warming system of claim 1, wherein the controller is programmed to determine none of the ejector elements in the region is active upon determining an activation data signal and/or a firing signal for the region is low.

4. The warming system of claim 1, wherein the controller is programmed to determine none of the ejector elements in the region is active upon determining both of an activation data signal and a firing signal for the region are low.

5. The warming system of claim 1, wherein the printhead includes multiple regions of multiple ejector elements and the warming system comprises:
a single warming circuit for each region, each warming circuit having a heating element distinct from any of the ejector elements; and
a controller for each warming circuit, each controller programmed to selectively energize the heating element in the corresponding warming circuit only upon determining the corresponding region is below a threshold temperature and none of the ejector elements in the corresponding region is active.

6. The warming system of claim 5, wherein the controller for each warming circuit is programmed to selectively energize the heating element in the corresponding warming circuit only upon determining the corresponding region is below a threshold temperature, none of the ejector elements in the corresponding region is active, and none of the ejector elements in an adjoining region is active.

7. The warming system of claim 1, wherein the heating element is a resistor and the warming circuit includes a field effect transistor to selectively energize the heating element at the direction of the controller.

8. The warming system of claim 1, wherein the controller programmed to selectively energize the heating element comprises a logic circuit having an output that is in an active state only upon determining none of the ejector elements in the region is active.

9. The warming system of claim 1, wherein the warming circuit is a single warming circuit.

10. A warming system fora region of multiple ejector elements on an inkjet printhead, the warming system comprising:
a field effect transistor; and
a logic circuit having an output to the transistor that is in an active state only when the region is below a threshold temperature and none of the ejector elements in the region is active.

11. The warming system of claim 10, comprising a controller programmed to drive the transistor through the logic circuit only upon determining the region of ejector elements is below a threshold temperature and only upon determining none of the ejector elements in the region is active.

12. The warming system of claim 11, comprising a resistor and wherein the controller is programmed to drive the transistor through the logic circuit to energize the resistor only upon determining the region of ejector elements is below a threshold temperature and only upon determining none of the ejector elements in the region is active.

13. A warming system fora region of multiple ejector elements on an inkjet printhead, the warming system comprising:
a thermal sensor;
a single warming circuit having a heating element distinct from any of the ejector elements; and
a logic circuit to detect a low temperature from the thermal sensor, to determine all of the ejector elements are inactive, and to energize the heating element only upon determining the temperature is low and all of the ejector elements are inactive.

14. The warming system of claim 13, wherein the logic circuit is to determine all of the ejector elements are inactive when an activation data signal and/or a firing pulse is low.

15. The warming system of claim 13, wherein the region comprises multiple regions of multiple ejector elements and the warming system comprises:
a thermal sensor for each region;
a single warming circuit for each region, each warming circuit having a heating element distinct from any of the ejector elements; and
a logic circuit for each region, each logic circuit to detect a low temperature from the thermal sensor, to determine all of the ejector elements in the region and in an adjoining region are inactive, and to energize the heating element for the region only upon determining the temperature is low and all of the ejector elements in the region and in the an adjoining region are inactive.
